(19) United States
(12) Patent Application Publication
(10) Pub. No.: US 2014/0329191 A1
(43) Pub. Date: Nov. 6, 2014

(54) Enhanced Bead Rack

(71) Applicant: Lindsey Elizabeth McNamara, Denver, CO (US)

(72) Inventor: Lindsey Elizabeth McNamara, Denver, CO (US)

(21) Appl. No.: 13/874,824

(22) Filed: May 1, 2013

(51) Int. Cl. F27D 5/00

(52) U.S. Cl. CPC F27D 5/0006
USPC 432/253

(57) ABSTRACT

An enhanced bead rack has a pair of supports. Each support has a front face, a back face, a top edge and a base. The front faces and back faces have a plurality of ports extending therethrough, and each port can receive therein one end of a wire. Beads, pendants, and other works can be threaded onto one or more wires and the wires can then be placed so that each end of each wire is supported by a port in each support. The plurality of ports can be arranged in various patterns or randomly and the number of ports can vary. Different sizes, shapes and styles of ports can be employed including: a grid of round ports, a series of long slots with notches, a series of long shelf spaces with notches, etc.

### TECHNICAL FIELD

The invention relates generally to the fields of jewelry, ceramics and design, and more particularly to a pair of enhanced bead racks that can be used to support pendants, beads, etc. during the kiln-firing process.

### BACKGROUND

People have been making ceramic jewelry, such as beads, pendants, etc., for thousands of years. However, traditional methods often require that portions of the works be laid flat within the kiln, causing problems with glazing, etc. For example, consider a typical round pendant having the shape of a cylinder with extremely short side walls relative to the diameter of the top and bottom circular surfaces: a one-quarter inch side wall height and a 2 inch diameter top and bottom surface results in a very flat, disc-shaped pendant. In order to fire such a pendant in a kiln, the pendant would have to be placed flat on either its top or bottom surface within the kiln. If placed on its bottom surface, the top and sides of the pendant could be glazed, but the bottom surface that is supporting the pendant could not.

This problem has persisted until the relatively recent development of high temperature metallic alloys. Such alloys can withstand the extreme temperatures inside a kiln and therefore can be used to support beads, pendants, etc. during the firing process. Such works can have a wire made from a high temperature alloy threaded through a hole in the pendant, bead, etc. and then the wire itself can be supported inside the kiln; thereby allowing all surfaces of the works (except, of course, the interior surfaces of the hole through which the wire runs) to be glazed or otherwise decorated.

However, a number of problems exist with the current means and methods utilized to suspend the high temperature alloy wires within kilns. One method uses a single support structure which holds the wires at an approximate mid-point of the wire (or at only one end of the wire). As heavy pendants or other works are added to the wires, the wires begin to deform, eventually drooping so much that the works near the unsupported ends of the wires are in danger of sliding off the wires and being damaged. Furthermore, such one-support-point systems are often shaped so as to resemble a Christmas tree wherein the wire support is a single trunk or cylinder and the wires radiate outwards from this central hub. Such an arrangement severely limits the size and number of pendants, beads, and other works than can be placed on the support system for firing.

Another known means for holding beads in a kiln is a wire and post system wherein beads are threaded onto a wire and then the wire is supported by two posts. Such systems solve the wire-droop problem, but are still limited in that they only offer a small number of configurations and placement options and severely limit the number, size and shape of works that can be fired concurrently. For example, some such systems only hold a single wire in a single, horizontal position. A large bead rack that can hold six wires is known, but it is also quite limited in that each of the six wires has a single holding location and although some of the six wires could be removed, they can not be repositioned to accommodate works of various sizes, nor can the wires be positioned slightly off the horizontal, if desired. Furthermore, such systems are inherently unstable and are easily knocked-over, often damaging the works. What is needed is a highly customizable means for securely supporting a large variety of works, having various shapes and sizes, in a compact manner to allow for the firing of many works at once.

### SUMMARY

One embodiment of the present invention provides an enhanced bead rack comprising a pair of supports. Each support has a front face, a back face, a top edge and a base. The front faces and back faces have a plurality of ports, and each port can receive therein one end of a wire. Beads, pendants, and other works can be threaded onto one or more wires and the wires can then be placed so that each end of each wire is supported by a port in each support. The plurality of ports can be arranged in various patterns or randomly and the density of ports per inch of area can vary. In one embodiment, a grid of ports is arranged with approximately one centimeter separating each port horizontally and vertically from its four neighboring ports. The diameter of the ports should be at least equal to or greater than the diameter of the wires. Various port diameters are contemplated in order to fit various diameters of wires. In another embodiment, the ports comprise long slots with notches. In yet another embodiment, the ports comprise long shelf spaces with notches. Also, it should be noted that smaller diameter wires can fit inside ports designed for larger diameter wires.

### BRIEF DESCRIPTION OF THE DRAWINGS

FIG. 1 illustrates a perspective view of an exemplary embodiment of an enhanced bead rack;

FIG. 2 illustrates a side elevation view of an exemplary embodiment of an enhanced bead rack;

FIG. 3 illustrates a front elevation view of an exemplary embodiment of an enhanced bead rack;

FIG. 4 illustrates a front elevation view of another exemplary embodiment of an enhanced bead rack;

FIG. 5 illustrates a side elevation view of another exemplary embodiment of an enhanced bead rack; and

FIG. 6 illustrates a top plan view of an exemplary embodiment of an enhanced bead rack.

### DETAILED DESCRIPTION

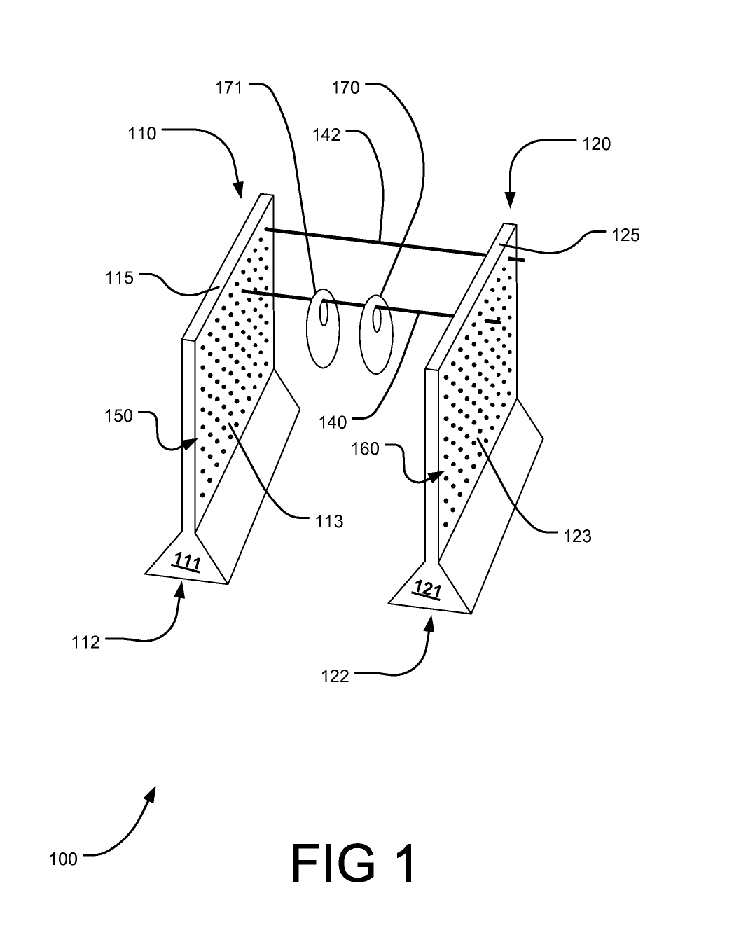

Referring now to the drawings, FIG. 1 illustrates a perspective view of an exemplary embodiment of an enhanced bead rack 100. The enhanced bead rack 100 has a first support 110 and a second support 120. The first support 110 has a front face 113 and a back face (not shown in FIG. 1), a top edge 115 and a bottom edge (not shown in FIG. 1), and a first base 111. Similarly, the second support 120 has a second front face 123 and a second back face (not shown in FIG. 1), a second top edge 125 and a second bottom edge (not shown in FIG. 1), and a second base 121.

The front faces and back faces are shown in FIG. 1 as having a generally flat surface. In other embodiments, the faces can be generally flat, curved, or a combination thereof. It is generally preferred that the faces, and indeed the entire first support 110 and second support 120, be generally shaped so as to be similar to one another, but other configurations are possible without departing from the scope of the invention.

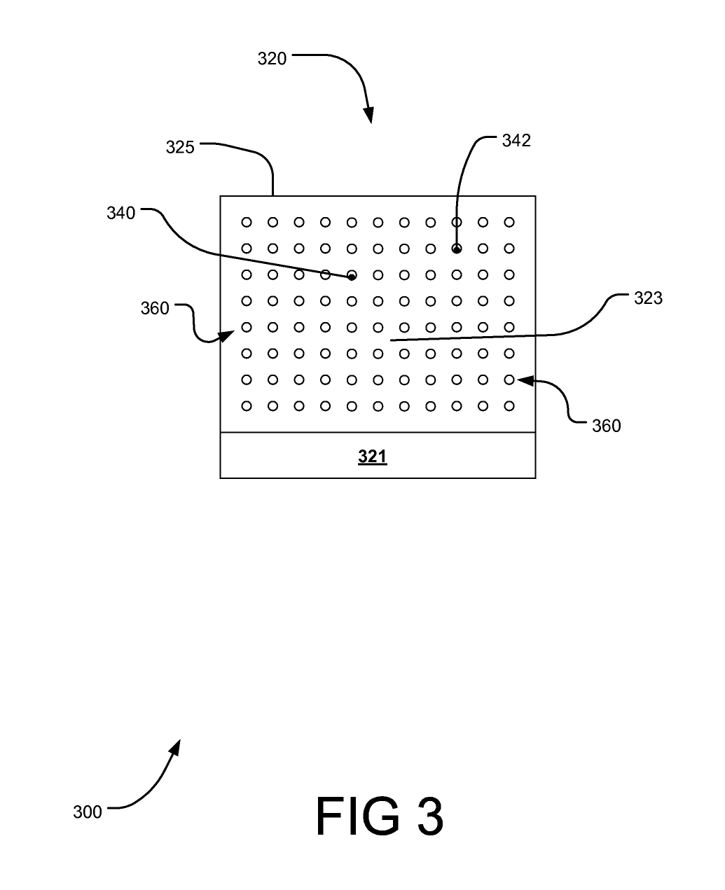

The first front face 113 of the first support 110 has a first plurality of ports 150 and the second front face 123 of the second support 120 has a second plurality of ports 160. One embodiment of the pluralities of ports 150 and 160 is shown in FIG. 1, another is shown in FIG. 3. Each port can receive therein one end of a wire. In FIG. 1, a plurality of wires 140 and 142 are shown for illustrative purposes. In other embodiments, the plurality of wires used could include one, two, three, or more wires. As discussed above, the diameter of the wires 140 and 142 can vary. In a preferred embodiment, twelve gauge Kanthal® A-1 wire is used. Other types and kinds of support wires can be used as long as they are relatively stiff and can withstand the high temperatures of an operating kiln. The material(s) used in constructing the wires can be any appropriately strong and relatively stiff material. The wires should generally retain their shape and stiffness as they are loaded with beads, pendants and other works; supported on each end by the first support 110 and the second support 120; and fired in a kiln at relatively high temperatures.

As can be seen in FIG. 1, once a plurality of beads, pendants, and other works 170 and 171 have been threaded onto one or more wires 140 and 142, the plurality of wires 140 and 142 can then be positioned within the pluralities of ports 113 and 123. Each wire has a first end which is placed through a first port on the first support 110 and a second end which is placed through a second port on the second support 120. The ports can be directly across from one another or they can be offset as desired by the user.

The pluralities of ports 150 and 160 can be arranged in various patterns or randomly and the density of ports per inch of area can vary. A preferred embodiment is a grid of ports arranged with approximately one centimeter separating each port horizontally and vertically from its four neighboring ports. The diameter of the ports should be at least equal to or greater than the diameter of the wires. Various port diameters are contemplated in order to fit various diameters of wires. Also, it should be noted that smaller diameter wires can fit inside ports designed for larger diameter wires.

The first support 110 has a first base 111 and the second support 120 has a second base 121. The bases 111 and 121 are structured so as to buttress the faces and keep them in a generally vertical orientation. Each base 111 and 121 has a bottom surface 112 and 122, respectively, that has a greater width than the distance between the front face and rear face pair for the corresponding support. The bottom surfaces 112 and 122 each have a length that is approximately equal to the horizontal length of the face 113 or 123 to which it is attached. Thus, each base 111 and 121 should have a relatively broad bottom surface 112 and 122 and can narrow near its top where the bases 111 and 121 intersect the bottoms of the faces 113 and 123. Although shown in FIG. 1 as being generally triangular in cross-sectional shape, in other embodiments the bases 111 and 121 can have other cross-sectional shapes that provide solid, well balanced structures to maintain the generally vertical positioning of the remaining portions of the supports 110 and 120. The bases 111 and 121 are configured to rest on generally flat surfaces (such as the inside work area of a kiln).

An enhanced bead rack can be fabricated using a variety of materials. Preferred embodiments can utilize either stoneware clay or a mixture of various types of stoneware clays as known in the art. For example, cordierite or high-alumina refractory material is commonly used for such applications. After shaping and glazing (decorating, etc.), enhanced bead racks can be fired and will then last indefinitely, with proper care.

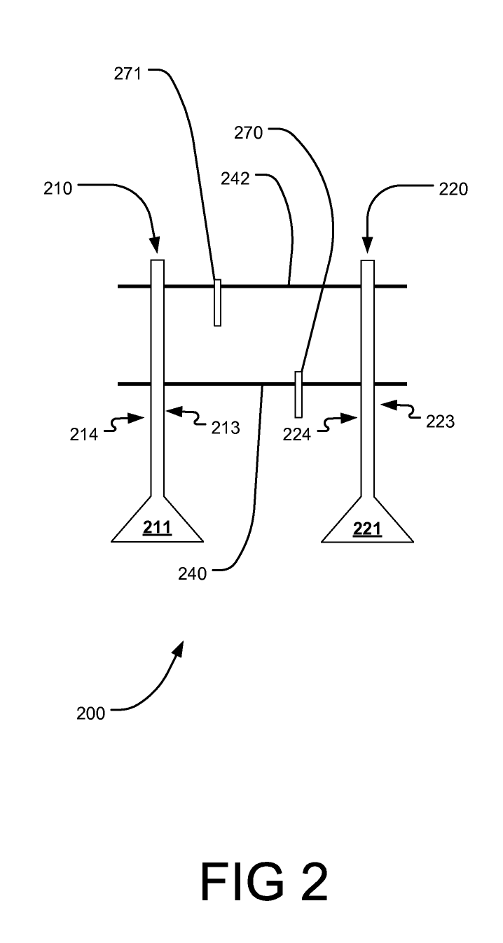

FIG. 2 illustrates a side elevation view of an exemplary embodiment of an enhanced bead rack 200. The enhanced bead rack 200 has a first support 210 and a second support 220. As the view presented in FIG. 2 is a side elevation view, the faces can not be directly viewed. They are, however, pointed to by the various reference numbers: for the first support 210, the first back face 214 and the first front face 213 are noted; for the second support 220, the second back face 224 and the second front face 223 are noted. The other components shown in FIG. 2 include: a first base 211 and a second base 221, a plurality of wires 240 and 242, a first pendant 270, and a second pendant 271.

As discussed previously, the first and second supports 210 and 220 shown in FIG. 2 have flat faces; however, in other embodiments, the faces can have curved surfaces. In yet other embodiments, the faces can be generally flat, curved, or a combination thereof. A generally flat face is a preferred embodiment.

The faces 213, 214, 223, and 224 have a plurality of ports which are visible in FIGS. 1 and 3, but not in FIG. 2. Each port can receive therein one end of a wire. In FIG. 2, a plurality of wires 240 and 242 are shown for illustrative purposes. The first wire 240 has a first pendant 270 threaded onto it and the first wire 240 is supporting the pendant 270 between the two supports 210 and 220. Similarly, the second wire 242 has a second pendant 271 threaded onto it and the second wire 242 is supporting the second pendant 271 between the two supports 210 and 220. Each wire 240 and 242 has a first end which is placed through a first port on the first support 210 and a second end which is placed through a second port on the second support 220. The ports can be directly across from one another or they can be slightly offset as desired by the user. It is preferred that the only points of contact between the pendants 270 and 271 (and any other beads, pendants, and other works) and the wires are small portions of the inside surfaces of the hanging holes on each piece. This allows the remaining surfaces of the works 270 and 271 to be glazed or otherwise decorated.

The generally triangular shape of the bases 211 and 221 can be seen in FIG. 2. However, as discussed above, in other embodiments the bases can generally resemble other shapes. Nevertheless, regardless of their general shape, the bases 211 and 221 should have generally broad bottom surfaces so as to securely hold the supports 210 and 220 in their upright configurations.

FIG. 3 illustrates a front elevation view of an exemplary embodiment of an enhanced bead rack 300. The view shows generally the second front face 323 of the second support 320. The second support 320 is illustrated with a second top edge 325. FIG. 3 also depicts the second base 321 of the second support 320.

The second front face 323 is highlighted in FIG. 3 in order to more clearly depict the second plurality of ports 360. As discussed above, the second plurality of ports 360 can be arranged in various patterns or they can be arranged randomly. The second plurality of ports 360 illustrated in FIG. 3 is configured in a grid pattern wherein the ports are arranged in rows and columns. In a preferred embodiment, each row is separated from the next by approximately one centimeter and each column is similarly separated from the next column by approximately one centimeter. In other embodiments, the ports are arranged differently and the density of ports per inch of area can vary as well. The diameter of the ports should be at least equal to or greater than the diameter of the wires. Various port diameters are contemplated in order to fit various diameters of wires. Also, it should be noted that smaller diameter wires can fit inside ports designed for larger diameter wires.

Each port can receive therein one end of a wire. In FIG. 3, two wires 340 and 342 are shown for illustrative purposes. In other embodiments, the plurality of wires used could include one, two, three, or more wires. As discussed above, the diameter of the wires 340 and 342 can vary. As can be seen in FIG. 3, the ends of the wires can be positioned so that they extend beyond the edge of the ports 360. This allows the wires 340 and 342 to be easily handled, positioned, etc. Furthermore, retaining pins, clamps, etc. can be placed on the ends of the wires to ensure that they remain in place. In other embodiments, the wires 340 and 342 do not protrude all the way through both sides of the ports 360.

The position of each wire can be configured as required by the user in order to have room for various sized works as well as various shaped works. For example, a row of extremely large pendants could hang from a wire on one side of the enhanced bead rack 300 while multiple rows of small beads are arranged around it. In that way, the majority of the available space is utilized and the number of different kiln firings that must be done to produce a given amount of finished works is reduced.

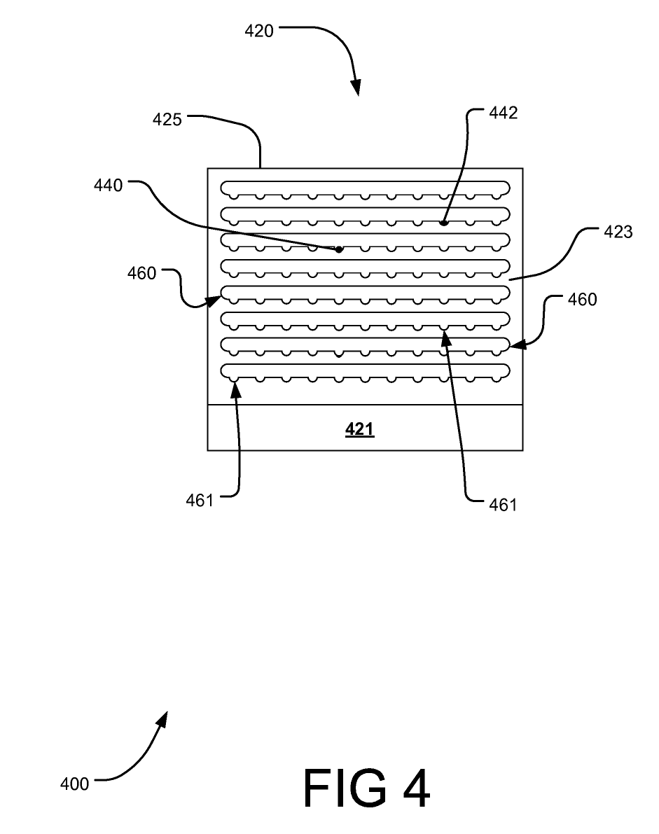

FIG. 4 illustrates a front elevation view of an exemplary embodiment of an enhanced bead rack 400. The view shows generally the second front face 423 of the second support 420. The second support 420 is illustrated with a second top edge 425. FIG. 4 also depicts the second base 421 of the second support 420.

The second front face 423 is highlighted in FIG. 4 in order to more clearly depict the second plurality of ports 460. In the embodiment shown in FIG. 4, the second plurality of ports 460 each consist of a long slot with a plurality of notches 461. The number of long slots shown in the embodiment illustrated in FIG. 4 is eight; in other embodiments, the number of long slots can be greater than or less than eight. The long slots extend generally horizontally, with one long slot above another. The long slots allow the wires 440 and 442 to be slid in from either side and then placed into the notch 461 of the user's choosing. In other embodiments, the ports are arranged differently and the density of notches 461 per inch of area can vary as well. The diameter of the notches 461 should be at least equal to or greater than the diameter of the wires 440 and 442. Various notch 461 diameters are contemplated in order to fit various diameters of wires 440 and 442. Also, it should be noted that smaller diameter wires 440 and 442 can fit inside notches 461 designed for larger diameter wires 440 and 442.

Each notch 461 can receive therein one end of a wire. In FIG. 4, two wires 440 and 442 are shown for illustrative purposes. In other embodiments, the plurality of wires used could include one, two, three, or more wires. As discussed above, the diameter of the wires 440 and 442 can vary. As can be seen in FIG. 4, the ends of the wires can be positioned so that they extend beyond the edge of the ports 460. This allows the wires 440 and 442 to be easily handled, positioned, etc. Furthermore, retaining pins, clamps, etc. can be placed on the ends of the wires to ensure that they remain in place. In other embodiments, the wires 440 and 442 do not protrude all the way through both sides of the ports 460.

In one embodiment, the first support can be similar to the embodiment shown in FIG. 3 while the second support 420 can be similar to the embodiment shown in FIG. 4. To use this embodiment, the wires are first placed in the ports in the first support and then the works to be fired are placed thereon. The second support 420 can then be placed near the free-hanging ends of the wires and slid into place parallel with the first support, being sure that each wire enters a slot that is approximately opposite the port in which the wire is placed in the first support. Once the two supports are approximately parallel and the wires are all in appropriate slots, then they can be finely aligned into appropriate notches on the second support.

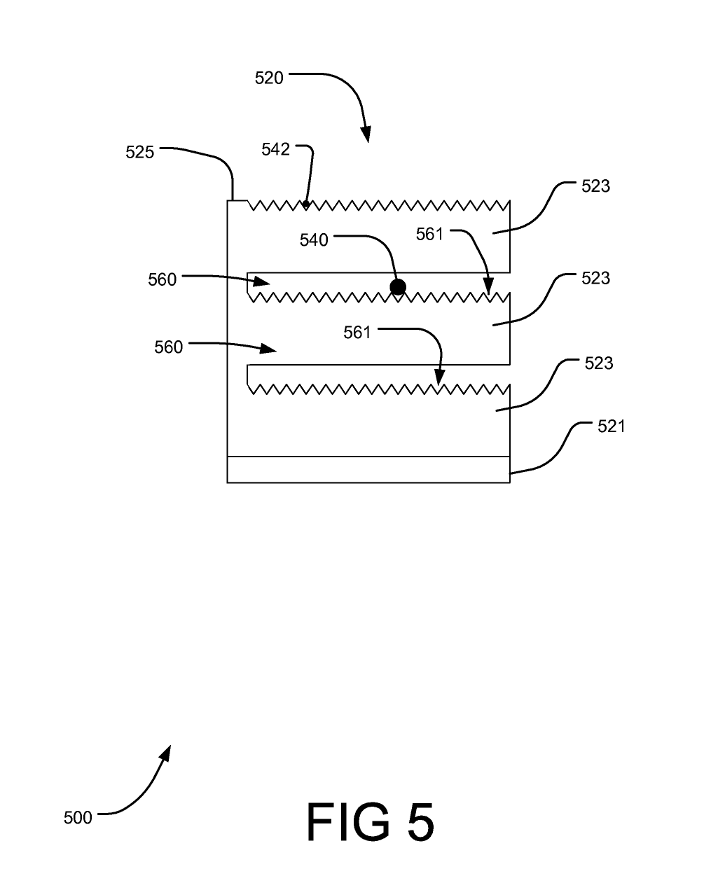

FIG. 5 illustrates a side elevation view of another exemplary embodiment of an enhanced bead rack 500. The view shows generally the second front face 523 of the second support 520. The second support 520 is illustrated with a second top edge 525. FIG. 5 also depicts the second base 521 of the second support 520. Although not shown in FIG. 5, the first support would look and function approximately similar to the second support 520 in this embodiment. In other embodiments, it is contemplated that the first support could look and function like that shown in FIG. 3 or FIG. 4 without departing from the scope of the invention.

The second front face 523 is highlighted in FIG. 5 in order to more clearly depict the second plurality of ports 560. In the embodiment shown in FIG. 5, the second plurality of ports 560 each consists of a long shelf space with a plurality of notches 561. The long shelf space extends generally horizontally across the second front face 523, with one long shelf space above another. In other embodiments, the height of each shelf space can be greater or less than those shown in FIG. 5. Although the embodiment illustrated in FIG. 5 shows two long shelf spaces, the actual number can be one, two, three, four, or more for a given embodiment. In the embodiment shown in FIG. 5, the second top edge 525 has an associated plurality of notches depicted therein; in other embodiments, the top edge 525 does not have an associated plurality of notches therein.

The long shelf spaces allow the wires 540 and 542 to be slid in from the side, placed from above, etc. The shelf spaces extend through one side wall of the front face 523, thereby causing the front face 523 to appear to be divided up into a series of shelves. Although the long shelf spaces are shown as being generally the same height from one end to the other in FIG. 5, it is contemplated that the beginning height of the shelf space may be less than the height of the shelf space as it extends through the side wall of the front face 523. This embodiment allows the user to hold one end of a given wire in each hand, thread the wire onto one of the shelves from the open side wall of the front face 523, and then place the wire into the notches 561 of the user's choosing. In other embodiments, the ports are arranged differently and the density of notches 561 per inch of area can vary as well. It is preferable, but not necessary, that the greatest width of each notch 561 should be at least equal to or greater than the diameter of the wires 540 and 542. Various notch 561 widths are contemplated in order to fit various diameters of wires 540 and 542. Also, it should be noted that smaller diameter wires 540 and 542 can fit inside notches 561 designed for larger diameter wires 540 and 542. In yet other embodiments, the notches 561 are not “V” shaped but instead have other shapes such as U-shaped, partial circular-shapes, etc. Furthermore, the notches 561 may be spaced further apart from one another than that shown in the embodiment of FIG. 5.

Each notch 561 can receive therein one end of a wire. In FIG. 5, two wires 540 and 542 are shown for illustrative purposes. In other embodiments, the plurality of wires used could include one, two, three, or more wires. As discussed above, the diameter of the wires 540 and 542 can vary. The ends of the wires can be positioned so that they extend beyond the plane of the front face 523. This allows the wires 540 and 542 to be easily handled, positioned, etc. Furthermore, retaining pins, clamps, etc. can be placed on the ends of the wires to ensure that they remain in place. In other embodiments, the wires 540 and 542 do not extend beyond the plane of the front face 523.

The position of each wire can be configured as required by the user in order to have room for various sized works as well as various shaped works. For example, a row of extremely large pendants could hang from a wire on one side of the enhanced bead rack 500 while multiple rows of small beads are arranged around it. In that way, the majority of the available space is utilized and the number of different kiln firings that must be done to produce a given amount of finished works is reduced.

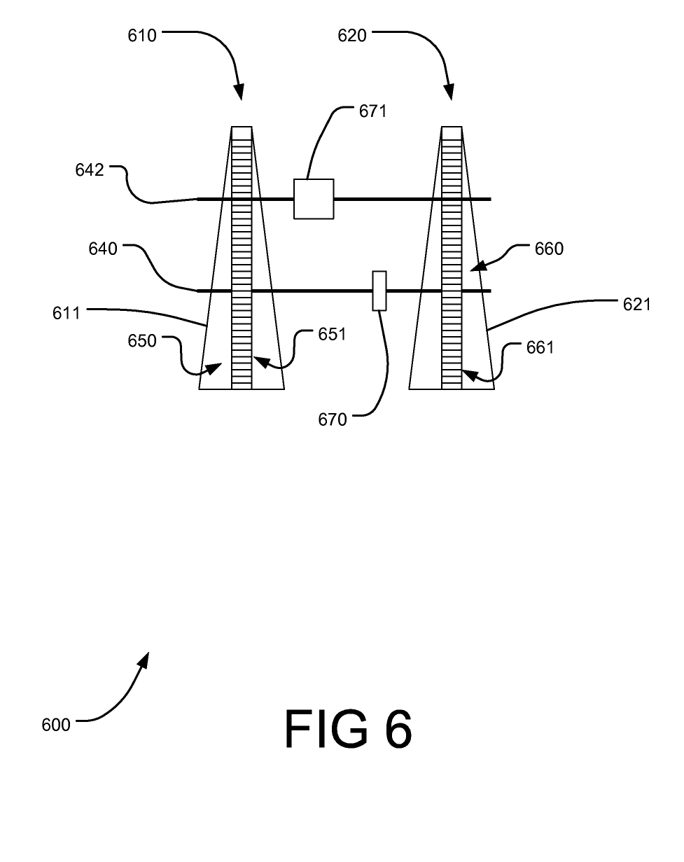

FIG. 6 illustrates a top plan view of an exemplary embodiment of an enhanced bead rack 600. The enhanced bead rack 600 has a first support 610 and a second support 620. As the view presented in FIG. 6 is a top plan view, the faces can not be directly viewed. However, the generally triangular shapes of the first base 611 and the second base 621 can be seen. This shape enhances the stability of the bases 611 and 621, keeping the first and second supports 610 and 620 from tipping front to back or side to side. The other components shown in FIG. 6 include: a plurality of wires 640 and 642, a first pendant 670, a second pendant 671, a first plurality of ports 650, a second plurality of ports 660, a first plurality of notches 651, and a second plurality of notches 661.

As more clearly seen in FIG. 5, the first and second plurality of ports 650 and 660 in FIG. 6 each consist of a long shelf with a plurality of notches 651 and 661 thereon. Each notch 651 and 661 can receive therein one end of a wire. In FIG. 6, a plurality of wires 640 and 642 are shown for illustrative purposes. The first wire 640 has a first pendant 670 threaded onto it and the first wire 640 is supporting the first pendant 670 between the two supports 610 and 620. Similarly, the second wire 642 has a second pendant 671 threaded onto it and the second wire 642 is supporting the second pendant 671 between the two supports 610 and 620. Each wire 640 and 642 has a first end which is placed into a first notch 651 on the first support 610 and a second end which is placed into a second notch 661 on the second support 620. The notches 651 and 661 can be directly across from one another or they can be slightly offset as desired by the user. It is preferred that the only points of contact between the pendants 670 and 671 (and any other beads, pendants, and other works) and the wires are small portions of the inside surfaces of the hanging holes on each piece. This allows the remaining surfaces of the works 670 and 671 to be glazed or otherwise decorated.

The generally triangular shape of the bases 611 and 621 can be seen in FIG. 6. However, as discussed above, in other embodiments the bases can generally resemble other shapes. Nevertheless, regardless of their general shape, the bases 611 and 621 should have generally broad bottom surfaces so as to securely hold the supports 610 and 620 in their upright configurations. For example, in another embodiment the portion of the bases 611 and 621 below the upright portion of each support 610 and 620 could be as wide as, or wide than, the opposite end of the bases 611 and 621. Furthermore, instead of being generally triangular in shape when viewed from above, the bases 611 and 621 could be circular or otherwise curved, square, rectangular, pentangular, etc. without departing from the scope of the invention.

While particular embodiments of the invention have been described and disclosed in the present application, it should be understood that any number of permutations, modifications, or embodiments may be made without departing from the spirit and scope of this invention. Accordingly, it is not the intention of this application to limit this invention in any way except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise embodiment or form disclosed herein or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

In light of the above “Detailed Description,” the Inventor may make changes to the invention. While the detailed description outlines possible embodiments of the invention and discloses the best mode contemplated, no matter how detailed the above appears in text, the invention may be practiced in a myriad of ways. Thus, implementation details may vary considerably while still being encompassed by the spirit of the invention as disclosed by the inventor. As discussed herein, specific terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

The above specification, examples and data provide a description of the structure and use of exemplary implementations of the described articles of manufacture and methods. It is important to note that many implementations can be made without departing from the spirit and scope of the invention.

What is claimed is:

1. An enhanced bead rack, comprising:
a first support having a first front face extending generally vertically, a first back face positioned in proximity to the first front face and also extending generally vertically, and a first base in association with the first front face and first back face such that the first base buttresses and holds the first front face and the first back face in a generally vertical orientation relative to a generally flat surface upon which the first base is configured to rest;
a first plurality of ports extending through the first front face and the first back face;
a second support having a second front face extending generally vertically, a second back face positioned in proximity to the second front face and also extending generally vertically, and a second base in association with the second front face and second back face such that the second base buttresses and holds the second front face and the second back face in a generally vertical orientation relative to the generally flat surface upon which the second base is configured to rest;
a second plurality of ports extending through the second front face and the second back face; and
a plurality of wires, each wire having a first end that is placed in the first plurality of ports and a second end that is placed in the second plurality of ports, thereby suspending each wire above the generally flat surface such that a work piece can be hung from the plurality of wires, and the enhanced bead rack, with the work piece hung therefrom, can be fired in a kiln.

2. The enhanced bead rack of claim 1, wherein the first front face, the first back face, the second front face, and the second back face each extend in approximately parallel planes and the planes are approximately perpendicular to the generally flat surface.

3. The enhanced bead rack of claim 1, wherein the first plurality of ports are generally round in shape and have a first diameter that is larger than a second diameter of the plurality of wires.

4. The enhanced bead rack of claim 1, wherein the second plurality of ports are generally round in shape and have a first diameter that is larger than a second diameter of the plurality of wires.

5. The enhanced bead rack of claim 2, wherein the first plurality of ports are generally round in shape and have a first diameter that is larger than a second diameter of the plurality of wires.

6. The enhanced bead rack of claim 2, wherein the second plurality of ports are generally round in shape and have a first diameter that is larger than a second diameter of the plurality of wires.

7. The enhanced bead rack of claim 3, wherein the second plurality of ports are generally round in shape and have a third diameter that is larger than the second diameter of the plurality of wires.

8. The enhanced bead rack of claim 5, wherein the second plurality of ports are generally round in shape and have a third diameter that is larger than the second diameter of the plurality of wires.

9. The enhanced bead rack of claim 1, wherein the first plurality of ports further comprise a plurality of long slots, wherein each slot has a plurality of notches along a bottom edge, the plurality of notches configured to retain the second ends of the plurality of wires.

10. The enhanced bead rack of claim 1, wherein the first plurality of ports comprises a plurality of long shelf spaces, each having an associated plurality of notches; wherein the plurality of long shelf spaces extends generally horizontally across the first front face and through a side wall of the first front face.

11. The enhanced bead rack of claim 2, wherein the first plurality of ports comprises a plurality of long shelf spaces, each having an associated plurality of notches; wherein the plurality of long shelf spaces extends generally horizontally across the first front face and through a side wall of the first front face.

12. The enhanced bead rack of claim 10, wherein the second plurality of ports comprises a second plurality of long shelf spaces, each having an associated plurality of notches; wherein the second plurality of long shelf spaces extends generally horizontally across the second front face and through a side wall of the second front face.

13. The enhanced bead rack of claim 11, wherein the second plurality of ports comprises a second plurality of long shelf spaces, each having an associated plurality of notches; wherein the second plurality of long shelf spaces extends generally horizontally across the second front face and through a side wall of the second front face.
